(19) United States
(12) Patent Application Publication
(10) Pub. No.: US 2005/0018795 A1
(43) Pub. Date: Jan. 27, 2005

(54) Low cost, high integrity digital signal processing

(75) Inventors: John Studenny, Montreal (CA); Daniel Domey, Montreal (CA)

Correspondence Address: Ogilvy Renault, Suite 1600, 1981 McGill College Avenue, Montreal, QC, H3A 2Y3, CA

(73) Assignee: CMC Electronics Inc.

(21) Appl. No.: 10/448,215

(22) Filed: May 30, 2003

(51) Int. Cl. H04L 27/06

(52) U.S. Cl. 375/343

(57) ABSTRACT

A digital signal processing system includes a digital hardware path for processing digital input data to generate respective digital output data, and at least two algorithmically distinct and mathematically equivalent software processes. Each process independently controls the digital hardware path to generate respective digital output data based on the digital input data.

### CROSS-REFERENCE TO RELATED APPLICATIONS

This is the first application filed for the present invention.

### MICROFICHE APPENDIX

Not Applicable.

### TECHNICAL FIELD

The present invention relates to digital signal processing systems, and in particular to low cost, high integrity digital signal processing methods and systems.

### BACKGROUND OF THE INVENTION

In general, all digital signal processing systems utilize a digital hardware path for processing digital input data. This digital hardware path can be composed of any combination of “hardwired” special purpose digital logic and software-driven microprocessor circuitry required to process the digital input data to yield a desired result. Such digital signal processing systems are becoming increasingly popular for use in safety of life applications, such as, for example, aviation electronics (avionics) such as navigation, precision approach, flight management, and medical electronic systems.

The use of the NAVSTAR Global Positioning System (commonly referred to as GPS) for navigation is well known in the art. For aviation navigation, a GPS receiver is installed in an aircraft, and provides accurate Position, Velocity and Time (PVT) data. In precision approach applications it's understood that PVT information and angular guidance are equivalent. The accuracy of the PVT data will normally depend on the number of GPS satellites that are “visible” to the GPS receiver. Generally, PVT accuracy increases with the number of visible satellites, but beyond 12 satellites, any further accuracy improvements are marginal.

Significant accuracy and integrity improvements can be obtained using the Wide Area Augmentation System (WAAS), which uses geo-synchronous WAAS Satellites to supplement the GPS satellite constellation. In ICAO terminology, WAAS is understood to be a Space Based Augmentation System (SBAS).

The Local Area Augmentation System (LAAS) is a ground based augmentation to GPS that focuses its service in the immediate vicinity of an airport (e.g., within a 20 nautical mile radius of the airport). The LAAS broadcasts differential GPS correction and integrity messages from a ground-based Very High Frequency (VHF) transmitter. LAAS has demonstrated a position accuracy of less than 1 meter in both the horizontal and vertical axis. In ICAO terminology, LAAS is understood to be a Ground Based Augmentation System (GBAS).

There is great interest in using augmented GPS with WAAS and/or LAAS as a replacement for the traditional radio beacon-based Instrument Landing System (ILS). While WAAS is envisioned to support Federal Aviation Administration (FAA) Category I Precision Approach, LAAS has been proposed as a technique for meeting the extremely high accuracy, availability, continuity, and integrity necessary for Category I, II, and III precision approaches.

However, an impediment to the adoption of GPS (WAAS and/or LAAS) Precision Approach (for category I, II, and III) is that the GPS receiver installed in an aircraft must simultaneously satisfy the applicable accuracy, availability, continuity, and integrity requirements.

In order to satisfy the FAA Category I (CAT-1) requirements, the Probability of Continuity of Operation (PCO) must be very high (e.g., at least 0.99999); and the Probability of Hazardously Misleading Information (PHMI) must be very low (e.g., 10⁻⁷ or less).

Note that algorithms and software that are provably adequate for CAT-1 (or even CAT-2/3) are known. The difficulty is in establishing the GPS receiver system correctness as a result of data processing error whatever the cause (e.g. hardware failure, poor signal quality). The GPS receiver system must provably process the data correctly, as the algorithms/software intended, with a PHMI of less than 10⁻⁷. Typically, the GPS receiver PHMI works out to about 10⁻⁵, which effectively precludes achievement of the CAT-1 PMHI requirement.

GPS receiver systems capable of achieving a PCO of 0.99999 with a PHMI of 10⁻⁷ or less are known in the art. As shown in FIG. 1a, one such solution employs a GPS receiver 2 which includes an RF block 8 and a digital hardware path 4 made up of a multi-channel correlator 10, and a microprocessor 12. The RF block 8 provides conventional analog circuitry which operates to receive and down-convert a composite signal 14 received from the satellites (not shown) to baseband. A conventional analog-to-digital (A/D) converter 15 then samples the baseband signal at a predetermined sample rate to generate a corresponding digital representation 16 of the baseband signal. The digital representation 16 of the baseband signal is then supplied, as digital input data of the hardware path 4, to each channel 18 of the multi-channel correlator 10. Each channel 18 of the correlator 10 is driven by the microprocessor 12 in a known manner to operate as either a Phase Locked Loop (PLL) or a Frequency Locked Loop (FLL), to detect and synchronize with a signal received from a respective one of the satellites. A software process executing in the microprocessor 12 can then use phase information derived from each of the channels 18 to calculate respective pseudo-range data for each satellite, which, in combination with time information derived from the satellite signals, is then used to derive PVT data 20 of the GPS receiver 2. A fault monitor 22 continuously monitors the microprocessor 12 and multi-channel correlator 10 of the hardware path 4, in order to detect faulty operation.

An alternative approach is illustrated in FIG. 1b. In this case, a pair of independent (and substantially identical) hardware paths 4 are connected in parallel. Each path 4 will usually be coupled to a respective antenna 6, although a common antenna 6 may be used. In either case, each path 4 independently generates respective PVT data 20.

Statistical processes can then be used to compare (at 24) the respective PVT data 20 generated by each of the two parallel hardware paths 4, to generate final output data 26. This operation can be performed by a central processing unit (not shown) which runs independently of the hardware paths 4, or by one of the microprocessors 12, as desired. In either case, this dual path architecture can be shown to yield a PHMI of about 10⁻¹⁰ for the final PVT data 22, even when each path 4 has a respective PHMI of about 10⁻⁵. What allows this is the fact that different processing paths will cause statistically independent computational failures. When these computational results are compared to determine whether a computation fault has occurred, then the probability of both computational paths making the same error is the product of the individual error probabilities. Therefore two independent failures with a probability of 10⁻⁵ when cross-checked yield a probability of error of (10⁻⁵)²=10⁻¹⁰.

It is instructive to note that the aviation industry loosely refers to such GPS systems as a “dual” GPS receiver, implying dual and independent digital hardware paths. It has been the industry practice to have two separate hardware paths with corresponding independent software processes that can detect a computational error before that error can adversely affect aircraft guidance used, for example, during a precision approach. The reason why such dual hardware paths are used is because the single path GPS receivers typically do not have the capability to check their own results for correctness at a level that meets or exceeds the PHMI requirements imposed by Category I or higher Precision Approaches. The solution thus far has been to use two independent hardware paths 4 with the corresponding independent software processes to detect errors.

The prior art high integrity digital signal processing systems, such as the GPS systems 2 illustrated in FIGS. 1a and 1b, suffer various disadvantages. For example, the use of two parallel paths 4 dramatically increases the cost of the complete system. The cost penalty can be mitigated to some extent by minimizing the size and complexity of each path 4. However, because of high accuracy requirements, the correlator 10 and microprocessor 12 within each path 4 must still be able to handle at least 8 channels according to RTCA DO-253A, but preferably 12, so the opportunity for reducing size and complexity of each path 4 is severely limited. Economies of scale can be obtained by making each path 4 physically identical, and running identical software processes in both microprocessors 12.

An additional limitation of the prior art is that the use of two paths 4 in parallel effectively doubles the hardware, which, in turn, doubles the probability of a hardware failure. This has the undesirable effect of lowering the PCO of the overall system.

Accordingly, low cost high integrity digital processing systems and methods, suitable for safety of life applications remain highly desirable.

### SUMMARY OF THE INVENTION

An object of the present invention is to provide a low cost, high integrity digital signal processing system.

Accordingly, an aspect of the present invention provides a high integrity GPS receiver system. The system comprises: a multichannel correlators for detecting each satellite signal, and for generating respective phase and timing information of each satellite signal; a microprocessor; and at least two algorithmically distinct (unless verified by other techniques such as continuous built-in testing) and mathematically equivalent computation processes implemented within the microprocessor for independently determining respective position data from the phase and timing information of each satellite signal.

A further aspect of the present invention provides a method for determining at least position data using a plurality of satellite signals received from a respective plurality of satellites. The method comprises steps of: providing a multichannel correlator for detecting each satellite signal, and for generating respective phase and timing information of each satellite signal; providing a microprocessor; and implementing at least two algorithmically distinct (unless verified by other techniques such as continuous built-in testing) and mathematically equivalent processes within the microprocessor for independently determining respective position data from the phase and timing information of each satellite signal.

A further (another) aspect of the present invention provides a method for determining the integrity of the RF block. It is recognized that it is rather difficult and costly to determine whether the RF block contributes to the lose of GPS PVT integrity due to component failure. Should there be an RF block integrity failure, the received GPS signals could undergo enough distortion/degradation so as to cause an undetectable PVT error. One aspect of this invention provides a simple and cost-effective means of detecting such a failure. This aspect is that there are more than one RF blocks on the GPS receiver. These RF blocks use the same reference oscillator and feed their down-converted signals to any one of the digital processing channels or correlators. This architecture provides the means for generating the PVT solution from each RF block for comparison. Should there be a large discrepancy, one of the RF blocks would be determined to have failed. Note that signal comparison can be performed prior to a PVT solution. Clearly, this technique includes any antennae failures as well. These RF blocks can also be used as data sources for the above mentioned independent algorithms.

### BRIEF DESCRIPTION OF THE DRAWINGS

Further features and advantages of the present invention will become apparent from the following detailed description, taken in combination with the appended drawings, in which:

FIGS. 1a and 1b are block diagrams schematically illustrating principle elements of respective conventional high-integrity GPS receiver systems;

FIG. 2 is a block diagram schematically illustrating principle elements of a high-integrity GPS receiver system in accordance with a first embodiment of the present invention; and

FIG. 3 is a block diagram schematically illustrating principle elements of a high-integrity GPS receiver system in accordance with a second embodiment of the present invention.

It will be noted that throughout the appended drawings, like features are identified by like reference numerals.

### DETAILED DESCRIPTION OF THE PREFERRED EMBODIMENT

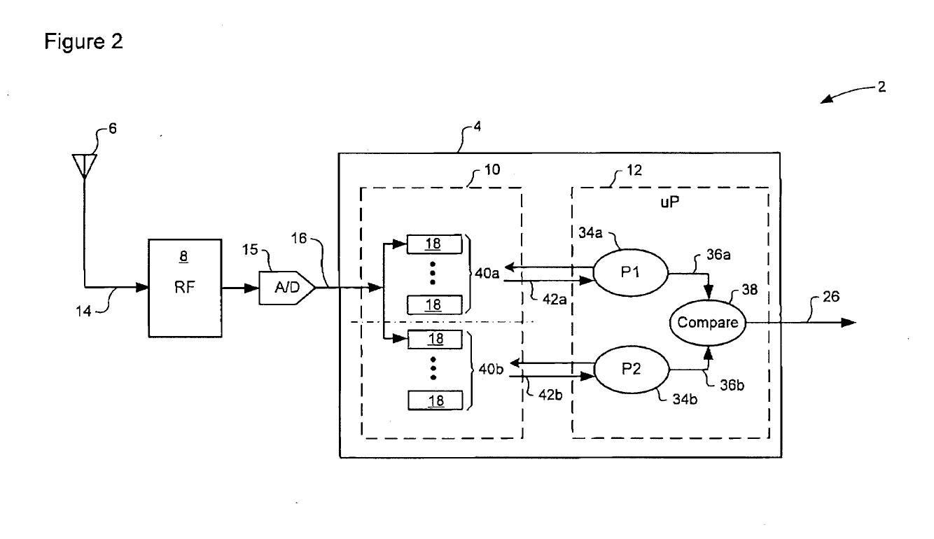

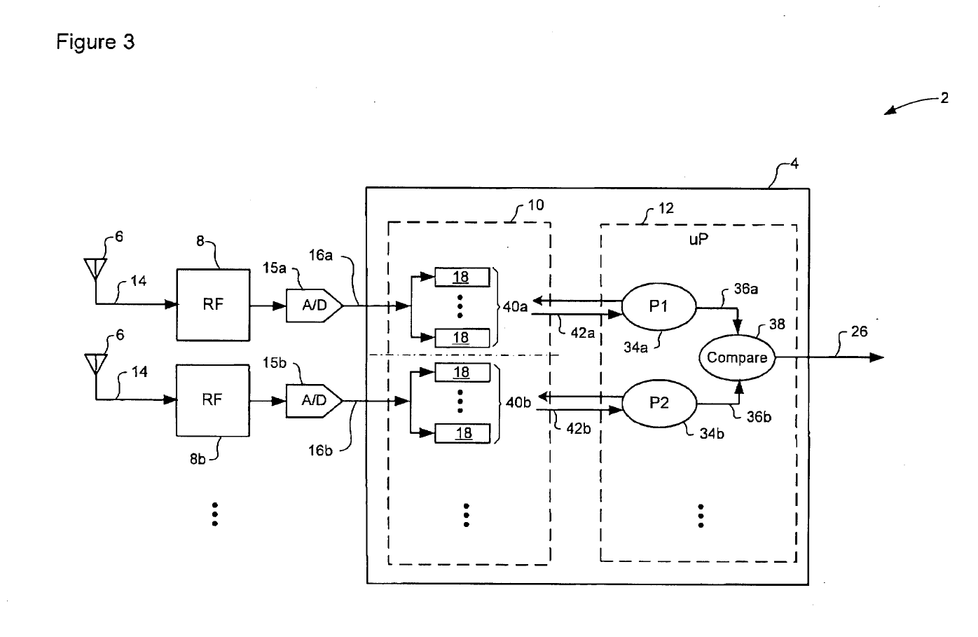

The present invention provides a low cost, high integrity digital processing methods and techniques, which are suitable for safety of life applications. Typical applications include medical electronics and aviation electronics (avionics) such as aircraft navigation, precision approach and flight management systems. By way of example only, the present invention is described by way of a GPS receiver system capable of satisfying the FAA mandated CAT-1 (or higher) requirements for precision approaches. Embodiments of a GPS receiver system in accordance with the present invention will be described below, by way of example, with reference to FIGS. 2 and 3.

FIG. 2 is a block diagram schematically illustrating principle elements of a high integrity GPS receiver 28 in accordance with a first embodiment of the present invention. As shown in FIG. 2, the GPS receiver 28 comprises a conventional antenna 6 and RF block 8, coupled to a digital hardware path 4 comprising a multi-channel correlator 10 and a microprocessor 12. In general, the method of the present invention operates by implementing a pair of algorithmically distinct but mathematically equivalent software processes 34 within the microprocessor 32. For the purposes of the present invention, the phrase “mathematically equivalent” shall be understood to mean that each software process, when operating correctly on the same digital input data, shall produce substantially identical output data. For the purposes of the present invention, the phrase “algorithmically distinct” shall be understood to mean that there is at least one non-trivial difference between the involved algorithms, such that the probability that processing errors (due to any cause) occurring within the hardware path 4 will produce an undetectable difference between the respective output data generated by each software process 34 is very low (e.g. significantly less than 10⁻¹⁰) for the GPS system of FIGS. 2 and 3. Each software process 34 yields respective PVT data 36, which can then be compared (at 38) to generate the final PVT data 26. Various known algorithms can be certified for CAT-1 precision approaches, and may be used for each software process 34, including: Kalman filter, Minimum Variance Least Squares, and iterative or analytical techniques.

As discussed above, in order to achieve satisfactory position accuracy, each software process 34 operates on phase and timing information from all satellites in view, up to at least 8 but preferably 12. In the embodiment of FIG. 2, this requirement is satisfied by logically dividing a conventional 24-channel correlator 10 to thereby allocate a set 40 of 12 channels to each software process 34. Within each set 40, each channel 18 is driven by the associated process 34 to detect and synchronize with a signal received from a respective one of the satellites (not shown). In general, the operation of each channel 18 is substantially conventional. However, different loop control techniques are preferably utilized in each set 40. For example, in one set 40a, each channel 18 can be driven by software process 34a to operate as a Phase Locked Loop (PLL); while in the other set 40b, each channel 18 may be driven by software process 34b to operate as a Frequency Locked Loop (FLL). Respective different loop bandwidths may also be implemented within each set 40. As a further alternative, one (or both) of the sets 40 of correlator channels 18 may be driven using a Fourier Transform matched filter technique. In this case, different bin widths may be used in each set 40.

As may be appreciated, the correlator channels 18 of each set 40 will yield respective different phase and timing information 42 for each satellite. While this phase and timing information 42 will be of substantially equivalent accuracy, the values will be different, as a result of the different loop control techniques (and/or bandwidth) implemented within each set 40. This approach increases the level of distinctiveness of the processes, each software process 34 not only uses different algorithms but also operates on different phase and timing data. This improves the ability of the compare 38 to detect errors. Obviously, impairments within any one channel within the pair that processes the same satellite will produces a different result for each channel. Furthermore, poor signal quality present at the antenna 6 (e.g. due to RF interference) or due to an impairment within the RF block 8 (e.g. due to common mode noise) will also propagate through the correlator 28 differently within each logical path 32 because of the different properties of the algorithms in the presence of poor quality signals.

Various known event scheduling and/or task management techniques may be used to control the microprocessor 32 to independently execute each of the software processes 34. For example, each software process 34 may be divided into discrete operational steps or sub-processes (not shown), in which case steps (or sub-processes) of each of the processes 34 may be “interleaved” so that each process 34 generates its respective PVT data 36 substantially simultaneously. Alternatively, each computation process 34 may be executed in turn, and the resulting PVT data 36 of each process 34 then processed (not shown) to compensate for the time lag between generation of the PVT data 36 of each process 34. If desired, software processes 34 may be controlled to execute at different rates. For example, one software process 34 may be controlled to execute at a much slower rate, which is limited only by the time to alarm requirement of the application. The resulting PVT data 36 of each of the processes 34 can then compared (at 38) at the lower rate.

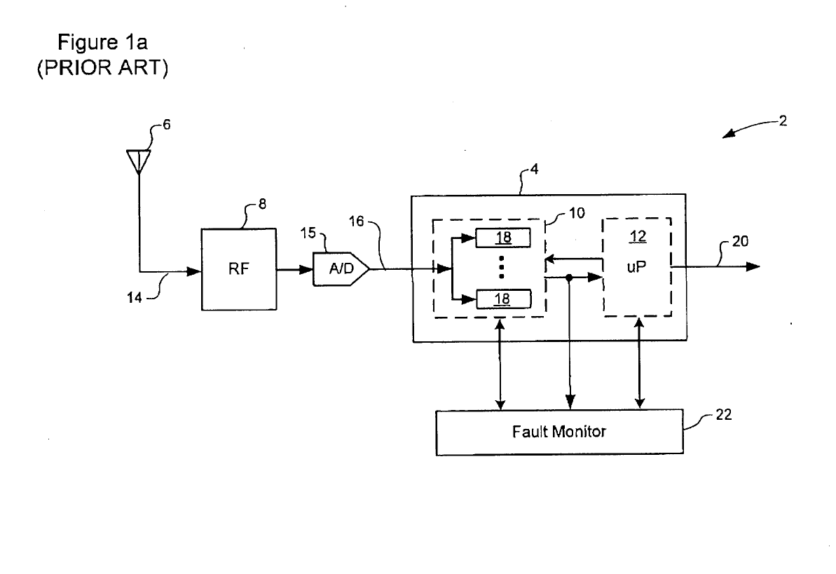

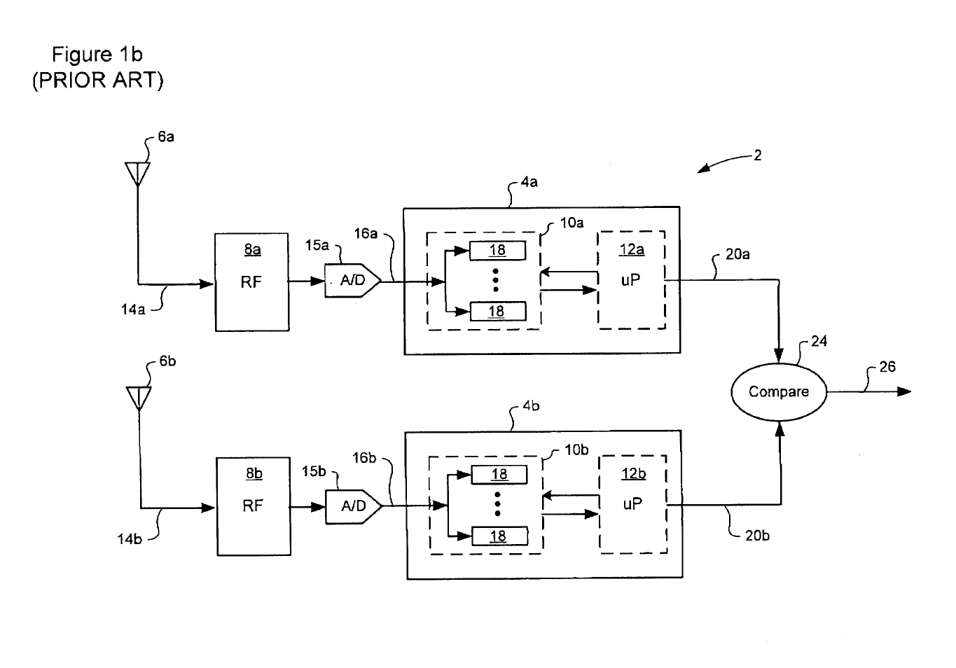

As discussed above, because different loop control methods are implemented within each set 40 of correlator channels 18, most common mode errors generated in the RF block 8 or due to poor signal quality at the antenna 6 will propagate through the correlator 30 differently in each set 40. For common mode errors having a large enough magnitude to be of significance in the application, this will produce statistically significant differences between the phase and timing data 42 generated by set 40 of channels 18. Furthermore, because of the algorithmic differences between each of the software processes 34 implemented in the microprocessor 32, any statistically significant differences in the phase and timing information 42 will yield a correspondingly statistically significant difference in the PVT data 36 generated by each process 34. As a result, most common mode errors occurring within the RF block a and/or A/D converter 15 can be detected by comparing the PVT data 36 generated by each of the processes 34. In addition, the actual measurements of pseudo range and delta range may be compared prior to a comparison of the PVT solutions. More importantly, however, any computation errors occurring within each process 34 (e.g. due to a fault of either the correlator 10 or the microprocessor 12) will also propagate through each process 34 differently, and produce a statistically significant difference between the PVT data 36 generated by each process 34. It is therefore possible to detect the presence of a computation error occurring in either the correlator 10 or the microprocessor 12 of the GPS receiver 2. As may be appreciated, this type of operation is simply not possible in prior art GPS receivers 4 (see FIGS. 1a and 1b), in which a single software process is implemented within each path 4.

As may be appreciated, more than two processes 34 may be utilized within the microprocessor 12, if desired. The primary limitations here are that the correlator 10 must provide sufficient channels 18 to permit calculation of sufficiently accurate PVT data 36 by each process 34, and the microprocessor 12 must be capable of operating at sufficient speed to enable each software process 34 to execute within the available time. For example, in order to satisfy CAT-1, the GPS system 2, as a whole, must update position data at a rate of at least 5 but often at 10 times per second. In order to meet this requirement, all of the computation processes 34 must be able to generate respective PVT data 36 within the available 0.1 second update period. Provided that this computational performance can be maintained by the microprocessor 12, three or more software processes 34 may be implemented within the microprocessor 12. As may be appreciated, this has an advantage in that a voting scheme may be implemented (e.g. at 38) so that continued guidance of a precision approach may be possible even in the event of a computational error effecting one of the software processes 34.

FIG. 3 is a block diagram schematically illustrating principle elements of a high integrity GPS receiver 2 in accordance with a second embodiment of the present invention. As may be seen, the embodiment of FIG. 3 is similar to that of FIG. 2 in that respective algorithmically unique but mathematically equivalent software processes 34 are implemented within the microprocessor 12. However, in this case, each process 34 operates on digital input data 16 generated by a respective PF block 8 and A/D converter 15. This arrangement has an advantage that errors occurring in any one RF block 8 and/or A/D converter 15 will yield a detectible difference in respective digital input data streams 16. This difference may be detected by directly monitoring the error in the input data streams 16 and/or by comparison between the PVT data 36 generated by each software process 34.

In the case where a single RF block 8 is present, a failure in one RF block 8 may not be detectable. In the case of GPS, examining the code correlation function may not provide any indication of a signal anomaly induced by a failure in the RF block. However, two or more RF blocks 8 provide the means to determine independent PVT solutions that can be compared to determine the integrity of the RF blocks 8.

The embodiment(s) of the invention described above is(are) intended to be exemplary only. The scope of the invention is therefore intended to be limited solely by the scope of the appended claims.

1. A digital signal processing system comprising:
a digital hardware path for processing digital input data to generate respective digital output data; and
at least two algorithmically distinct and mathematically equivalent software processes for independently controlling the digital hardware path to generate respective digital output data based on the digital input data.

2. A digital signal processing system as claimed in claim 1, wherein the digital hardware path comprises any or more of:
a digital logic circuit; and
a microprocessor for executing each software process.

3. A digital signal processing system as claimed in claim 1, wherein each software process executes substantially concurrently.

4. A digital signal processing system as claimed in claim 1, wherein each software process executes sequentially.

5. A Global Positioning System (GPS) receiver for determining at least position data using a plurality of satellite signals received from a respective plurality of satellites, the receiver comprising:
a digital hardware path for digitally processing digital input data from an RF receiver block to generate at least positioning data; and
at least two algorithmically distinct and mathematically equivalent software processes for independently controlling the digital hardware path to generate at least respective position data from the digital input data.

6. A GPS receiver as claimed in claim 5, wherein the digital hardware path comprises any or more of:
a digital logic circuit; and
a microprocessor for executing each software process.

7. A GPS receiver as claimed in claim 5, wherein the digital input data comprises a digital representation of a composite satellite signal received by the RF receiver block.

8. A GPS receiver as claimed in claim 5, wherein each software process executes substantially concurrently.

9. A GPS receiver as claimed in claim 5, wherein each software process executes sequentially.

10. A GPS receiver as claimed in claim 5, wherein the digital hardware path comprises:
a multichannel correlator for detecting each satellite signal within the digital input data, and for generating respective phase and timing information of each satellite signal; and
a microprocessor for executing each software process.

11. A GPS receiver as claimed in claim 5, wherein the respective algorithmically unique and mathematically equivalent process comprises any one of: a Kalman filter solution; minimum variance least squares solution; an iterative solution and an analytical solution.

12. A GPS receiver as claimed in claim 10, wherein each process receives phase and timing information from a respective set of parallel channels driven by the process in accordance with a respective correlation technique.

13. A GPS receiver as claimed in claim 12, wherein each set of parallel channels is operatively connected to receive digital input data from a common RF receiver block.

14. A GPS receiver as claimed in claim 12, wherein each set of parallel channels is operatively connected to receive digital input data from a respective different RF receiver block.

15. A GPS receiver as claimed in claim 12, wherein each satellite signal is independently processed by a respective one channel of each set.

16. A GPS receiver as claimed in claim 12, wherein the respective correlation technique implemented by each process comprises any one of: a Phase Locked Loop (PLL); a Frequency Locked Loop (FLL); and a Fourier Transform matched filter technique.

17. A GPS receiver as claimed in claim 16, wherein the respective correlation technique implemented by each process comprises a respective different loop bandwidth.

18. A GPS receiver as claimed in claim 16, wherein the respective correlation technique implemented by each process comprises a respective different bin width.

19. A GPS receiver as claimed in claim 5, further comprising means for comparing the respective position data generated by each process.

20. A method for determining at least position data using a plurality of satellite signals received from a respective plurality of satellites, the method comprising steps of:
providing a multichannel correlator for detecting each satellite signal within a received composite satellite signal, and for generating respective phase and timing information of each satellite signal;
providing a microprocessor; and
implementing at least two algorithmically distinct and mathematically equivalent software processes within the microprocessor for independently determining respective position data from the phase and timing information of each satellite signal.

21. A method as claimed in claim 20, wherein the respective algorithmically unique and mathematically equivalent process comprises any one of: a Kalman filter solution; a minimum variance least squares solution; an iterative solution and an analytical solution.

22. A method as claimed in claim 20, further comprising a step of logically dividing the multichannel correlator into two or more sets of parallel channels, each set of channels being driven by a respective software process in accordance with a respective correlation technique.

23. A method as claimed in claim 22, wherein the respective correlation technique implemented within each set of channels comprises any one of: a Phase Locked Loop (PLL); a Frequency Locked Loop (FLL); and a Fourier Transform matched filter technique.

24. A method as claimed in claim 23, wherein the respective correlation technique implemented within each set of channels comprises a respective different loop bandwidth.

25. A method as claimed in claim 23, wherein the respective correlation technique implemented within each set of channels comprises a respective different bin width.

26. A method as claimed in claim 22, wherein each set of channels receives a digital representation of the received composite satellite signal from a respective RF receiver.

27. A method as claimed in claim 20, further comprising a step of comparing the respective position data generated by each process.

28. A method as claimed in claim 27, wherein the position data comprises any one of:
pseudo range; and
delta range data.
